(19) United States
(12) Patent Application Publication
(10) Pub. No.: US 2026/0274328 A1
(43) Pub. Date: Sep. 17, 2026

(54) Steering Operation Input Device and Steer-By-Wire Type Steering Device

(71) Applicant: Astemo, Ltd., Chiyoda-ku, Tokyo (JP)

(72) Inventors: Takafumi OJIO, Hitachinaka-shi, Ibaraki (JP); Hirotoshi UCHIBORI, Hitachinaka-shi, Ibaraki (JP)

(21) Appl. No.: 19/166,828

(22) PCT Filed: Dec. 1, 2023
(86) PCT No.: PCT/JP2023/043103

§ 371 Date: Sep. 18, 2025

(30) Foreign Application Priority Data
May 10, 2023 (JP) 2023-077541

(51) Int. Cl. B62D 5/00; B62D 5/04

(52) U.S. Cl. CPC B62D 5/001; B62D 5/0445

(57) ABSTRACT

Steering operation input device includes a first shaft (19), a second shaft (20), a coupling member (13) provided between the first and second shafts (19, 20), a first torsion spring (16) provided at the first shaft (19) and connected to the coupling member (13), and a second torsion spring (17) provided at the second shaft (20). The second torsion spring (17) has the same spring constant as that of the first torsion spring (16). A pre-load is applied to the second torsion spring (17). Until the first shaft (19) is twisted by 60 degrees in a predetermined rotation direction, an urging force of the first torsion spring (16) acts on the first shaft (19). After the first shaft (19) is twisted by 60 degrees in the predetermined rotation direction, an urging force of the first torsion spring (16) and the second torsion spring (17) acts on the first shaft (19).

### TECHNICAL FIELD

The present invention relates to a steering operation input device and a steer-by-wire type steering device.

### BACKGROUND ART

As a steering operation input device, for instance, a steering operation input device described in the following Patent Document 1 has been known.

The steering operation input device of the Patent Document 1 has a first urging member for generating a reaction force against one rotation direction of a steering operation input member of a steering device, and a second urging member for generating a reaction force against the other rotation direction, which is opposite to the one rotation direction, of the steering operation input member. Switching of generation of the reaction force by the first urging member and the second urging member is performed via a linear motion conversion device that converts a rotational force, which is input from the steering operation input member, into a linear motion.

### CITATION LIST

### Patent Document

Patent Document 1: Japanese Unexamined Patent Application Publication No. 2015-082071

### SUMMARY OF THE INVENTION

### Technical Problem

In the steering operation input device of the Patent Document 1, since dedicated urging members to generate the reaction forces against the respective rotation directions of the steering operation input member are provided, parts count for the steering operation input device increases, which causes a problem of increasing manufacturing costs of the steering operation input device.

The present invention was devised in view of the conventional situation. An object of the present invention is therefore to provide a steering operation input device that is capable of reducing the manufacturing costs.

### Solution to Problem

As one aspect of the present invention, a steering operation input device comprises an urging member which provides an urging force against rotation of a shaft, and this urging member includes: a first urging member which provides an urging force to the shaft regardless of a rotation direction of the shaft; and a second urging member which is attached with a pre-load being applied to the second urging member, and which provides, after the first urging member provides the urging force, an urging force to the shaft regardless of the rotation direction of the shaft.

### Effects of Invention

According to the present invention, it is possible to reduce the manufacturing costs of the steering operation input device.

### BRIEF DESCRIPTION OF THE DRAWINGS

FIG. 1 is a schematic diagram of a steer-by-wire type steering device to which a steering operation input device of the present invention is applied.

FIG. 2 is a longitudinal cross section of a steering operation input device according to a first embodiment.

FIG. 3 is an explanatory diagram showing a positional relationship between a first torsion spring, a first arc groove and a second arc groove of a first shaft at a neutral position when viewed from an axial direction of the first shaft.

FIG. 4 is an explanatory diagram showing a positional relationship between the first torsion spring, the first arc groove and the second arc groove of the first shaft when rotating the first shaft rightward (clockwise) from the neutral position.

FIG. 5 is an explanatory diagram showing a positional relationship between the first torsion spring, the first arc groove and the second arc groove of the first shaft when rotating the first shaft leftward (counterclockwise) from the neutral position.

FIG. 6 is a graph showing an operation force with respect to an operation angle according to the first embodiment.

FIG. 7 is a longitudinal cross section of a steering operation input device according to a second embodiment.

FIG. 8A is an explanatory diagram showing the steering operation input device when rotating a third shaft leftward by 180 degrees from a neutral position. FIG. 8B is an explanatory diagram showing the steering operation input device when rotating the third shaft leftward by 60 degrees from the neutral position. FIG. 8C is an explanatory diagram showing the steering operation input device at the neutral position.

FIG. 9A is an explanatory diagram showing the steering operation input device at a neutral position. FIG. 9B is an explanatory diagram showing the steering operation input device when rotating the third shaft rightward by 60 degrees from the neutral position. FIG. 9C is an explanatory diagram showing the steering operation input device when rotating the third shaft rightward by 180 degrees from the neutral position.

FIG. 10 is a graph showing an operation force with respect to an operation angle according to a third embodiment.

### EMBODIMENTS FOR CARRYING OUT THE INVENTION

Embodiments of a steering operation input device according to the present invention will be described below with reference to the drawings. In the following embodiments, examples in which the steering operation input device is applied to a steer-by-wire type steering device mounted on a vehicle will be described.

### First Embodiment

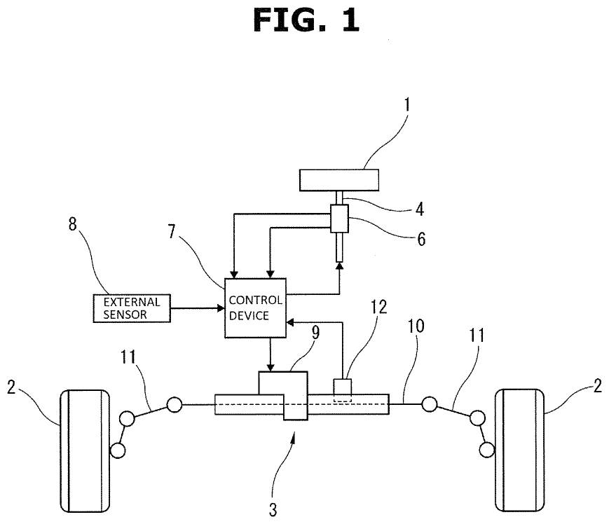

FIG. 1 is a schematic diagram of a steer-by-wire type steering device to which a steering operation input device of the present invention is applied.

The steer-by-wire type steering device is configured so that the steering operation input device described later into which a steering operation is input via a dial 1, which is a steering operation input member by which a driver performs a steering operation, and a steering mechanism 3 that steers a pair of steered wheels 2 and 2, are mechanically separated.

The dial 1 is fixed to one end portion of a shaft 4 that is a column shaft provided at the steering operation input device. It is noted that, instead of the dial 1, another steering operation input member such as a steering wheel, could be fixed to the one end portion of the shaft 4. An operation angle sensor 6 to detect an operation angle (a steering angle) of the shaft 4 according to the steering operation by the driver is provide at an outer peripheral portion of the shaft 4. An operation angle signal (a steering angle signal) detected by the operation angle sensor 6 is transmitted to a control device 7. Also, various detection signals other than the steering angle signal are transmitted to the control device 7 by an external sensor 8. The control device 7 controls an electric motor 9 provided at the steering mechanism 3, based on the steering angle signal, after-mentioned steering amount signal and various detection signals.

The steering mechanism 3 includes a steered shaft 10, a pair of tie rods 11 and 11 connected to both end portions of the steered shaft 10 and steering the pair of steered wheels 2 and 2, the electric motor 9 controlling a steering operation of the steered shaft 10, and a steering amount sensor 12 detecting a steering amount signal of the steered shaft 10. The steering amount signal detected by the steering amount sensor 12 is transmitted to the control device 7.

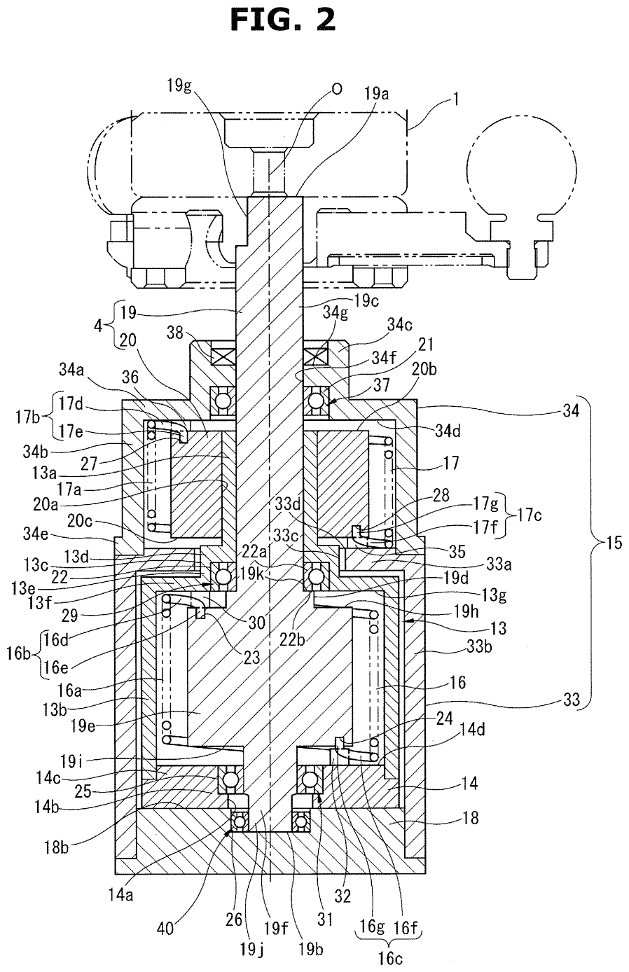

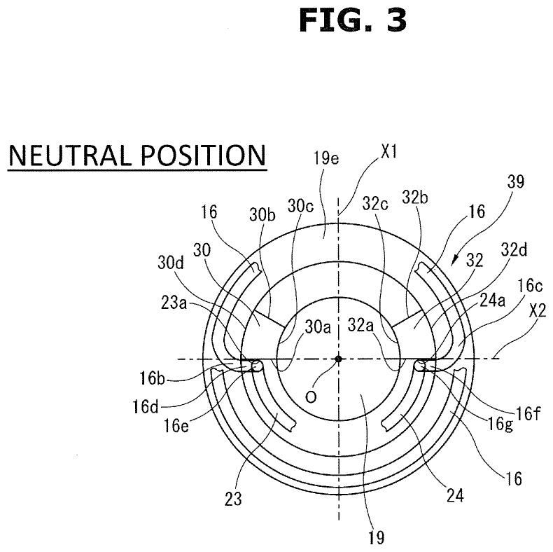

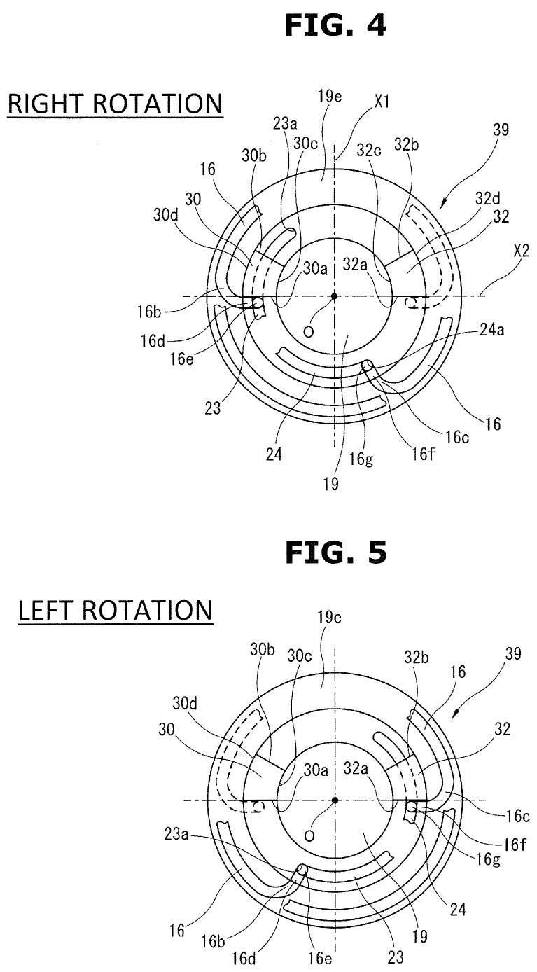

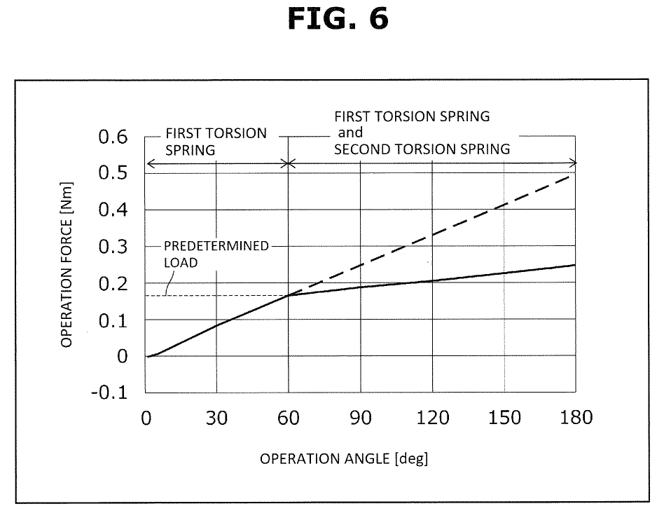

FIG. 2 is a longitudinal cross section of the steering operation input device according to a first embodiment. In FIG. 2, for the same of simplicity, the operation angle sensor 6 is omitted. FIG. 3 is an explanatory diagram showing a positional relationship between a first torsion spring 16, a first arc groove 23 and a second arc groove 24 of a first shaft 19 at a neutral position when viewed from an axial direction of the first shaft 19. In FIG. 3, although the first arc groove 23 and the second arc groove 24 are illustrated as if these first and second grooves 23 and 24 are formed on the same plane, in reality, the first arc groove 23 is formed on an axial direction one end surface 19h, whereas the second arc groove 24 is formed on an axial direction other end surface 19i which is located at a position shifted from the axial direction one end surface 19h toward the other end portion 19b of the first shaft 19. FIG. 4 is an explanatory diagram showing a positional relationship between the first torsion spring 16, the first arc groove 23 and the second arc groove 24 of the first shaft 19 when rotating the first shaft 19 rightward (clockwise) from the neutral position. FIG. 5 is an explanatory diagram showing a positional relationship between the first torsion spring 16, the first arc groove 23 and the second arc groove 24 of the first shaft 19 when rotating the first shaft 19 leftward (counterclockwise) from the neutral position. FIG. 6 is a graph showing an operation force with respect to an operation angle according to the first embodiment.

The steering operation input device includes the shaft 4, a coupling member 13, a coupling member lid 14, a housing 15, the first torsion spring (a first urging member) 16, a second torsion spring (a second urging member) 17, and a closing member 18.

The shaft 4 includes the first shaft 19 to which an operation force from the dial 1 is transmitted and which rotates on a rotation axis O, and a second shaft 20 which is connected to the first shaft 19 via the coupling member 13 and the first torsion spring 16. For convenience of the following description, in FIG. 2, of both end portions 19a and 19b in an axial direction of the first shaft 19, the end portion at a side where the dial 1 is fixed is defined as “one end portion 19a”, whereas the end portion at an opposite side to the side where the dial 1 is fixed is defined as “the other end portion 19b”. Further, in FIG. 3, a center line which passes through the rotation axis O of the first shaft 19 and divides the first shaft 19 into right and left is defined as “a first center line X1”. Also, a center line which passes through the rotation axis O of the first shaft 19 and is orthogonal to the first center line X1 is defined as “a second center line X2”. It is noted that a direction along the second center line X2 in FIG. 3 coincides with a right-left direction in FIG. 2.

The shaft 4 has a first small diameter portion 19c that is a shaft portion located on one end portion 19a side, a medium diameter portion 19d that is formed integrally with the first small diameter portion 19c and that is a shaft portion having a larger diameter than the first small diameter portion 19c, a large diameter portion 19e that is formed integrally with the medium diameter portion 19d and that is a shaft portion having a larger diameter than the medium diameter portion 19d, and a second small diameter portion 19f that is formed integrally with the large diameter portion 19e and that is a shaft portion having a smaller diameter than the large diameter portion 19e.

A D-cut portion 19g for engagement with the dial 1 is formed at an outer peripheral portion, on one end portion 19a side, of the first small diameter portion 19c. The D-cut portion 19g is fixed to the dial 1 via, for instance, a well-known key connection. A first ball bearing 21, which is a bearing for rotatably supporting the first small diameter portion 19c, is provided at an outer periphery of an axial direction middle portion of the first small diameter portion 19c. Further, a second ball bearing 22, which is a bearing for rotatably supporting the first small diameter portion 19c, is provided at an outer peripheral portion of an axial direction end portion, located on the other end portion 19b side, of the first small diameter portion 19c.

The large diameter portion 19e is a shaft portion around which the first torsion spring 16 is attached. An outside diameter of the large diameter portion 19e is set to be smaller than an inside diameter of the first torsion spring 16 when the first torsion spring 16 is twisted and compressed to its maximum extent. As illustrated in FIG. 2, the large diameter portion 19e has the axial direction one end surface 19h which is located on one end portion 19a side and which is a ring-shaped continuous surface, and the axial direction other end surface 19i which is located on the other end portion 19b side and which is a ring-shaped continuous surface.

The first arc groove 23 having an arc shape concentric with an outer circumference of the first shaft 19 is formed at a position which is closer to an outer peripheral portion on the axial direction one end surface 19h on a side where the D-cut portion 19g of the first small diameter portion 19c of the first shaft 19 is provided. As illustrated in FIG. 3, the first arc groove 23 is positioned at a left side with respect to the first center line X1, and extends counterclockwise in an arc shape from the second center line X 2 at a predetermined angle, 180 degrees in the present embodiment. It is noted that the first arc groove 23 could be formed so as to continue in an arc shape at any angle other than 180 degrees. The first arc groove 23 has a first groove end 23a adjacent to the second center line X2, and a second groove end (not shown) that is located at an opposite side to the first groove end 23a. As depicted in FIG. 3, in a neutral state of the first torsion spring 16, a first bent portion 16e of a first spring end portion 16b, both described later, of the first torsion spring 16 is located at the first groove end 23a of the first arc groove 23.

On the other hand, the second arc groove 24 having an arc shape concentric with the outer circumference of the first shaft 19 and having the same shape as the first arc groove 23 is formed at a position which is closer to an outer peripheral portion on the axial direction other end surface 19i and which is diagonal to the first arc groove 23 across the rotation axis O of the first shaft 19. As illustrated in FIG. 3, the second arc groove 24 is positioned at a right side with respect to the first center line X1, and extends clockwise in an arc shape from the second center line X2 at a predetermined angle, 180 degrees in the present embodiment. It is noted that the second arc groove 24 could be formed so as to continue in an arc shape at any angle other than 180 degrees. The second arc groove 24 has a third groove end 24a adjacent to the second center line X2, and a fourth groove end (not shown) that is located at an opposite side to the third groove end 24a. As depicted in FIG. 3, in the neutral state of the first torsion spring 16, a second bent portion 16g of a second spring end portion 16c, both described later, of the first torsion spring 16 is located at the third groove end 24a of the second arc groove 24.

A third ball bearing 25, which is a bearing for rotatably supporting the second small diameter portion 19f, is provided at an outer peripheral portion of the second small diameter portion 19f. The second small diameter portion 19f has a step-reduced diameter portion 19j, which is formed by shaping a tip portion of the second small diameter portion 19f into a step-reduced diameter shape. A fourth ball bearing 26, which is a bearing for rotatably supporting the step-reduced diameter portion 19j, is provided at an outer peripheral portion of the step-reduced diameter portion 19j.

The second shaft 20 is formed into a cylindrical shape having a larger outside diameter than the large diameter portion 19e of the first shaft 19. The second shaft 20 has, at a center portion thereof, a circular first through hole 20a. Then, an after-mentioned small diameter tubular portion 13a of the coupling member 13, with the first small diameter portion 19c of the first shaft 19 penetrating the small diameter tubular portion 13a, is inserted into the first through hole 20a. The second shaft 20 has an axial direction one end-side end surface 20b which is located on one end portion 19a side and which is a ring-shaped continuous surface, and an axial direction other end-side end surface 20c which is located on the other end portion 19b side and which is a ring-shaped continuous surface.

A third arc groove 27 having an arc shape concentric with an outer circumference of the second shaft 20 is formed at a position which is closer to an outer peripheral portion on the axial direction one end-side end surface 20b of the second shaft 20. The third arc groove 27 has the same shape as that of the first arc groove 23, but is provided at an outer position with respect to the first arc groove 23 in a radial direction of the first shaft 19. It is noted that a positional relationship between the third arc groove 27 and an after-mentioned third protrusion 36 when the second torsion spring 17 is at a neutral position is the same as a positional relationship (a positional relationship shown in FIG. 3) between the first arc groove 23 and an after-mentioned first protrusion 30 when the first torsion spring 16 is at a neutral position.

Furthermore, a fourth arc groove 28 having an arc shape concentric with the outer circumference of the second shaft 20 is formed at a position which is closer to an outer peripheral portion on the axial direction other end-side end surface 20c of the second shaft 20 on an opposite side to the side where the D-cut portion 19g of the first small diameter portion 19c of the first shaft 19 is provided. The fourth arc groove 28 has the same shape as that of the second arc groove 24, but is provided at an outer position with respect to the second arc groove 24 in the radial direction of the first shaft 19. It is noted that a positional relationship between the fourth arc groove 28 and an after-mentioned fourth protrusion 35 when the second torsion spring 17 is at the neutral position is the same as a positional relationship (a positional relationship shown in FIG. 3) between the second arc groove 24 and an after-mentioned second protrusion 32 when the first torsion spring 16 is at the neutral position.

The coupling member 13 is formed into a cylindrical shape with a metal material or a resin. The coupling member 13 has the small diameter tubular portion 13a, a large diameter tubular portion 13b, and a connecting portion 13c connecting the small diameter tubular portion 13a and the large diameter tubular portion 13b. The first small diameter portion 19c of the first shaft 19 penetrates a space inside an inner peripheral surface of the small diameter tubular portion 13a. The inner peripheral surface of the small diameter tubular portion 13a is separated from an outer peripheral surface of the first small diameter portion 19c via a slight gap. A D-cut portion (not shown) is formed on an outer peripheral surface of the small diameter tubular portion 13a, and the D-cut portion is fixed to the first through hole 20a of the second shaft 20 via a well-known key connection. Here, instead of the well-known key connection, using a well-known screw connection, the first through hole 20a of the second shaft 20 could be fixed to the D-cut portion of the small diameter tubular portion 13a. Also, the first through hole 20a of the second shaft 20 may be fixed to the small diameter tubular portion 13a via a spline portion, instead of the D-cut portion.

The large diameter tubular portion 13b has a cylindrical shape having a larger diameter than the small diameter tubular portion 13a. The medium diameter portion 19d, the large diameter portion 19e, a part of the second small diameter portion 19f of the first shaft 19, and the first torsion spring 16 are accommodated inside the large diameter tubular portion 13b. An axial direction end portion, on one end portion 19a side, of the large diameter tubular portion 13b is connected to an axial direction end portion, on the other end portion 19b side, of the small diameter tubular portion 13a via the connecting portion 13c. On the other hand, an axial direction other end portion, on the other end portion 19b side, of the large diameter tubular portion 13b is covered by the coupling member lid 14.

The connecting portion 13c has a ring-shaped first annular expansion portion 13d expanding outward in the radial direction of the first shaft 19 from an outer periphery of the small diameter tubular portion 13a, a tubular protruding portion 13e having a tubular shape that protrudes from a radial direction end portion of the first annular expansion portion 13d to the other end portion 19b side, and a ring-shaped second annular expansion portion 13f expanding outward in the radial direction of the first shaft 19 from an outer peripheral portion of the tubular protruding portion 13e. A space inside an inner peripheral surface of the tubular protruding portion 13e is a first bearing accommodating portion 29 that accommodates the second ball bearing 22 which is the bearing for rotatably supporting the first small diameter portion 19c. In a state in which the second ball bearing 22 is accommodated in the first bearing accommodating portion 29, an end surface 22b, on the other end portion 19b side, of an inner race 22a of the second ball bearing 22 abuts against an end surface 19k, on one end portion 19a side, of the medium diameter portion 19d.

On a surface 13g, on the other end portion 19b side, of the second annular expansion portion 13f, at a position close to the first arc groove 23 of the large diameter portion 19e of the first shaft 19, the first protrusion 30 (shown by a solid line and a broken line in FIG. 2) is formed so as to protrude toward the large diameter portion 19e. More specifically, as illustrated in FIG. 3, the first protrusion 30 is provided in a region located at a left side with respect to the first center line X1 and also at an upper side with respect to the second center line X2, and is disposed at a position adjacent to the second center line X2. When the first torsion spring 16 is at the neutral position as shown in FIG. 3, the first protrusion 30 is adjacent to the first groove end 23a of the first arc groove 23. A width, along the radial direction of the first shaft 19, of the first protrusion 30 is greater than a width, along the radial direction of the first shaft 19, of the first arc groove 23. The first protrusion 30 has a first flat surface 30a along the second center line X2, a second flat surface 30b at an opposite side to the first flat surface 30a in a circumferential direction of the first shaft 19, a first arc surface 30c connecting inner end portions of the first flat surface 30a and the second flat surface 30b, and a second arc surface 30d connecting outer end portions of the first flat surface 30a and the second flat surface 30b. The first protrusion 30 is structured so that a first inclined portion 16d of the first spring end portion 16b, both described later, of the first torsion spring 16 can abut against the first flat surface 30a of the first protrusion 30.

The coupling member lid 14 is formed into a disk shape with a metal material or a resin. A second through hole 14a is formed at a center portion of the coupling member lid 14 so as to penetrate the coupling member lid 14 along the axial direction of the first shaft 19. The second through hole 14a is formed into a step-reduced diameter shape from one end portion 19a side to the other end portion 19b side via an annularly continuous step portion 14b. A space, on one end portion 19a side with respect to the step portion 14b, of the second through hole 14a is a second bearing accommodating portion 31 that accommodates the third ball bearing 25 which is the bearing for rotatably supporting the second small diameter portion 19f of the first shaft 19. Further, an annularly continuous step 14c is formed at an outer peripheral edge portion, on one end portion 19a side, of the coupling member lid 14, and the axial direction other end portion, on the other end portion 19b side, of the large diameter tubular portion 13b of the coupling member 13 is received in this step 14c. Then, the axial direction other end portion, on the other end portion 19b side, of the large diameter tubular portion 13b is fixed to the step 14c. A surface, located on the other end portion 19b side and facing the closing member 18, of the coupling member lid 14 is separated from a surface 18b, on one end portion 19a side, of the closing member 18 via a slight gap.

On a surface 14d, on one end portion 19a side, of the coupling member lid 14, at a position close to the second arc groove 24 of the large diameter portion 19e of the first shaft 19, the second protrusion 32 (shown by a solid line and a broken line in FIG. 2) is formed so as to protrude toward the large diameter portion 19e. More specifically, as illustrated in FIG. 3, the second protrusion 32 is provided in a region located at a right side with respect to the first center line X1 and also at an upper side with respect to the second center line X2, and is disposed at a position adjacent to the second center line X2. When the first torsion spring 16 is at the neutral position as shown in FIG. 3, the second protrusion 32 is adjacent to the third groove end 24a of the second arc groove 24. The second protrusion 32 is similar in shape to the first protrusion 30. A width, along the radial direction of the first shaft 19, of the second protrusion 32 is greater than a width, along the radial direction of the first shaft 19, of the second arc groove 24. The second protrusion 32 has a third flat surface 32a along the second center line X2, a fourth flat surface 32b at an opposite side to the third flat surface 32a in a circumferential direction of the first shaft 19, a third arc surface 32c connecting inner end portions of the third flat surface 32a and the fourth flat surface 32b, and a fourth arc surface 32d connecting outer end portions of the third flat surface 32a and the fourth flat surface 32b. The second protrusion 32 is structured so that a second inclined portion 16f of the second spring end portion 16c, both described later, of the first torsion spring 16 can abut against the third flat surface 32a of the second protrusion 32.

The housing 15 includes a first housing 33 located on the other end portion 19b side, and a second housing 34 located on one end portion 19a side.

The first housing 33 is formed into a bottomed tubular shape with a metal material or a resin. The first housing 33 accommodates therein a portion, on the other end portion 19b side with respect to the second ball bearing 22, of the first shaft 19, a part of the connecting portion 13c, and the large diameter tubular portion 13b of the coupling member 13, the first torsion spring 16, and the coupling member lid 14. The first housing 33 has a circular plate-shaped bottom wall portion 33a, and a cylindrical peripheral wall portion 33b extending from an outer peripheral edge portion of the bottom wall portion 33a to the other end portion 19b side. A third through hole 33c is formed at a center portion of the bottom wall portion 33a so as to penetrate the bottom wall portion 33a along the axial direction of the first shaft 19. The connecting portion 13c of the coupling member 13, with the first small diameter portion 19c of the first shaft 19 penetrating the connecting portion 13c, is inserted into the third through hole 33c. An inner peripheral surface of the third through hole 33c is separated from an outer peripheral surface of the connecting portion 13c. On a surface 33d, on one end portion 19a side, of the bottom wall portion 33a, at a position close to the fourth arc groove 28 of the second shaft 20, the fourth protrusion 35 (shown by a solid line and a broken line in FIG. 2) is formed so as to protrude toward the second shaft 20.

The second housing 34 is formed into a bottomed tubular shape with a metal material or a resin. The second housing 34 accommodates therein a part of the first small diameter portion 19c of the first shaft 19, the small diameter tubular portion 13a of the coupling member 13, the second shaft 20, and the second torsion spring 17. The second housing 34 has a bottom wall portion 34a, a cylindrical peripheral wall portion 34b extending from an outer peripheral edge portion of the bottom wall portion 34a to the other end portion 19b side, and a cylindrical expansion portion 34c expanding from a center portion of the bottom wall portion 34a to the dial 1 side. On a surface 34d, on the other end portion 19b side, of the bottom wall portion 34a, at a position close to the third arc groove 27 of the second shaft 20, the third protrusion 36 (shown by a solid line and a broken line in FIG. 2) is formed so as to protrude toward the second shaft 20. Further, an annular flange portion 34e protruding outward in the radial direction of the first shaft 19 is formed at an axial direction end portion, on the other end portion 19b side, of the peripheral wall portion 34b. This flange portion 34e is mounted on and fixed to the bottom wall portion 33a of the first housing 33 via a fixing member (not shown), e.g. bolts.

A fourth through hole 34f is formed at the bottom wall portion 34a and the expansion portion 34c so as to penetrate the bottom wall portion 34a and the expansion portion 34c in the axial direction of the first shaft 19. The first small diameter portion 19c of the first shaft 19 is inserted into the fourth through hole 34f. Furthermore, a third bearing accommodating portion 37, which is a circular recessed portion recessed from the surface 34d of the bottom wall portion 34a to one end portion 19a side, is formed at the bottom wall portion 34a and a part of the expansion portion 34c. The third bearing accommodating portion 37 accommodates the first ball bearing 21 rotatably supporting the first small diameter portion 19c of the first shaft 19. An annularly continuous annular groove portion 34g is formed at a position, on one end portion 19a side with respect to the first ball bearing 21, on an inner peripheral surface of the expansion portion 34c. The annular groove portion 34g is provided with an O-ring 38 as a seal member. The O-ring 38 seals a gap between the inner peripheral surface of the expansion portion 34c of the second housing 34 and the outer peripheral surface of the first small diameter portion 19c of the first shaft 19. The O-ring 38 causes the feeling of viscosity to be generated by friction with the first shaft 19 at the beginning of turning of the dial 1, and the driver can obtain the feeling of operating the dial 1 by the viscous feeling. Here, as long as the seal member seals the gap between the inner peripheral surface of the expansion portion 34c of the second housing 34 and the outer peripheral surface of the first small diameter portion 19c of the first shaft 19, the seal member is not limited to the O-ring 38. For instance, an oil seal or a dust seal could be provided. Further, the oil seal or the dust seal may be provided together with the O-ring 38.

The first torsion spring 16 is a linear spring that is attached to the large diameter portion 19e of the first shaft 19 via the first arc groove 23 and the second arc groove 24 of the first shaft 19 in a state in which no pre-load is applied to the spring. The first torsion spring 16 has a spiral portion 16a formed by spirally winding a long thin cylindrical columnar metal member, the hook-shaped first spring end portion 16b that is one end portion of the spiral portion 16a, and the hook-shaped second spring end portion 16c that is the other end portion of the spiral portion 16a. The first torsion spring 16 is provided so that the large diameter portion 19e of the first shaft 19 is inserted inside the spiral portion 16a. As illustrated in FIG. 2, the first spring end portion 16b has the first inclined portion 16d that is inclined from an axial direction one end of the spiral portion 16a to the first arc groove 23 side of the first shaft 19, and the first bent portion 16e that is bent from a tip portion of the first inclined portion 16d to the inside of the first arc groove 23. The second spring end portion 16c has the same shape as that of the first spring end portion 16b. The second spring end portion 16c has the second inclined portion 16f that is inclined from an axial direction other end of the spiral portion 16a to the second arc groove 24 side of the first shaft 19, and the second bent portion 16g that is bent from a tip portion of the second inclined portion 16f to the inside of the second arc groove 24.

A reaction force due to torsion of the first torsion spring 16 is generated by a position switching mechanism 39 shown in FIGS. 3 to 5. The position switching mechanism 39 includes the first arc groove 23 and the second arc groove 24 of the first shaft 19, the first bent portion 16e and the second bent portion 16g, which are inserted into the first arc groove 23 and the second arc groove 24 respectively, of the first torsion spring 16, the first protrusion 30 of the coupling member 13, and the second protrusion 32 of the coupling member lid 14. The position switching mechanism 39 switches between a non-fixed position and a fixed position of the first spring end portion 16b or the second spring end portion 16c at the first shaft 19 when the first shaft 19 is rotated by and according to the operation of the dial 1. That is, the position switching mechanism 39 switches, according to a rotation direction of the first shaft 19, a position of the first bent portion 16e inserted into the first arc groove 23 or the second bent portion 16g inserted into the second arc groove 24, from the fixed position to the non-fixed position. By this position switching mechanism 39, the first torsion spring 16 provides an urging force to the first shaft 19 regardless of the rotation direction of the first shaft 19. That is, by the position switching mechanism 39, the first torsion spring 16 provides the urging force to the first shaft 19 for either a right rotation direction or a left rotation direction of the first shaft 19.

As illustrated in FIG. 3, when the first torsion spring 16 is at the neutral position, the position switching mechanism 39 fixes both of the first bent portion 16e and the second bent portion 16g of the first torsion spring 16 at the fixed position. More specifically, the first inclined portion 16d formed integrally with the first bent portion 16e of the first spring end portion 16b abuts against the first flat surface 30a of the first protrusion 30 of the coupling member 13, then the position of the first bent portion 16e is fixed. On the other hand, the second inclined portion 16f formed integrally with the second bent portion 16g of the second spring end portion 16c abuts against the third flat surface 32a of the second protrusion 32 of the coupling member lid 14, then the position of the second bent portion 16g is fixed. It is noted that the above “neutral position” is a neutral position at which the dial 1 is not turned in either the right rotation (right turn) or the left rotation (left turn) with respect to a travelling direction of a vehicle, and thus the first torsion spring 16 is not twisted in either the right rotation direction or the left rotation direction.

When the first shaft 19 rotates to the right side (in the right rotation along the clockwise direction in FIG. 3) according to the right rotation of the dial 1, as shown in FIG. 4, while the first inclined portion 16d remains in contact with the first flat surface 30a of the first protrusion 30, the second bent portion 16g is pushed by the third groove end 24a of the second arc groove 24 that is rotating to the right, then is twisted to the non-fixed position, i.e. a position apart from the third flat surface 32a of the second protrusion 32 in the right rotation direction. With this, a reaction force (the urging force) is generated in the left rotation direction that is opposite to the right rotation direction of the first shaft 19.

On the other hand, when the first shaft 19 rotates to the left side (in the left rotation along the counterclockwise direction in FIG. 3) according to the left rotation of the dial 1, as shown in FIG. 5, while the second bent portion 16g remains in contact with the third flat surface 32a of the second protrusion 32, the first bent portion 16e is pushed by the first groove end 23a of the first arc groove 23 that is rotating to the left, then is twisted to the non-fixed position, i.e. a position apart from the first flat surface 30a of the first protrusion 30 in the left rotation direction. With this, a reaction force (the urging force) is generated in the right rotation direction that is opposite to the left rotation direction of the first shaft 19.

When the first torsion spring 16 configured as described above reaches a predetermined load due to the rotation of the first shaft 19, the coupling member 13 starts to rotate in the same direction as the rotation direction of the first shaft 19 via the abutment of the first inclined portion 16d against the first protrusion 30 or the abutment of the second inclined portion 16f against the second protrusion 32. Here, the “predetermined load” is a load generated by a pre-load set in (applied to) the second torsion spring 17. As shown in FIG. 6, in the present embodiment, the predetermined load is set to about 0.17 Nm, and this is set so that when an operation angle of the dial 1 is 60 degrees, the first torsion spring 16 reaches 0.17 Nm. Further, by and according to the rotation of the coupling member 13, the second shaft 20 fixed to the outer peripheral portion of the coupling member 13 also stars to rotate. At this time, even after the second shaft 20 has rotated, the first shaft 19 continues rotating continuously. Then, even after an urging force by the second torsion spring 17 is provided to the second shaft 20, the first torsion spring 16 continues providing the urging force to the first shaft 19. It is noted that instead of configuring the first torsion spring 16 and the second torsion spring 17 as above, it could be possible to employ a configuration in which even if rotation of the first torsion spring 16 providing the urging force to the first shaft 19 stops upon rotation of the dial 1, by a switching device (not shown), the urging force is provided to the shaft 4 only by the second torsion spring 17, that is, a configuration in which after the first torsion spring 16 provides the urging force to the first shaft 19, the second torsion spring 17 provides the urging force to the second shaft 20.

The second torsion spring 17 has the same spring constant as that of the first torsion spring 16. The second torsion spring 17 is a linear spring that is attached to the second shaft 20 via the third arc groove 27 and the fourth arc groove 28 of the second shaft 20 in a state in which a pre-load is applied to the spring. The second torsion spring 17 has a spiral portion 17a formed by spirally winding a long thin cylindrical columnar metal member, a third spring end portion 17b that is one end portion of the spiral portion 17a, and a fourth spring end portion 17c that is the other end portion of the spiral portion 17a. The second torsion spring 17 is provided so that the second shaft 20 is inserted inside the spiral portion 17a. As illustrated in FIG. 2, the third spring end portion 17b has a third inclined portion 17d that is inclined from an axial direction one end of the spiral portion 17a to the third arc groove 27 side of the second shaft 20, and a third bent portion 17e that is bent from a tip portion of the third inclined portion 17d to the inside of the third arc groove 27. The fourth spring end portion 17c has the same shape as that of the third spring end portion 17b. The fourth spring end portion 17c has a fourth inclined portion 17f that is inclined from an axial direction other end of the spiral portion 17a to the fourth arc groove 28 of the second shaft 20, and a fourth bent portion 17g that is bent from a tip portion of the fourth inclined portion 17f to the inside of the fourth arc groove 28. A reaction force due to torsion of the second torsion spring 17 is generated by a position switching mechanism similar to the position switching mechanism 39 applied to the first torsion spring 16. The position switching mechanism applied to the second torsion spring 17 includes the third arc groove 27 and the fourth arc groove 28 of the second shaft 20, the third bent portion 17e and the fourth bent portion 17g, which are inserted into the third arc groove 27 and the fourth arc groove 28 respectively, of the second torsion spring 17, the third protrusion 36 of the second housing 34, and the fourth protrusion 35 of the first housing 33. The position switching mechanism switches between a non-fixed position and a fixed position of the third spring end portion 17b or the fourth spring end portion 17c at the second shaft 20 when the second shaft 20 is rotated by and according to the rotation of the first shaft 19. That is, the position switching mechanism switches, according to a rotation direction of the second shaft 20, a position of the third bent portion 17e inserted into the third arc groove 27 or the fourth bent portion 17g inserted into the fourth arc groove 28, from a fixed position to a non-fixed position. The workings of the position switching mechanism for the second torsion spring 17 is the same as the workings of the position switching mechanism 39 for the first torsion spring 16, i.e. the above switching mechanism described with reference to FIGS. 4 and 5. By the position switching mechanism for the second torsion spring 17, the second torsion spring 17 provides an urging force to the second shaft 20 regardless of the rotation direction of the second shaft 20.

Furthermore, a rotary damper mechanism (not shown), which is a damper mechanism that applies a damping force to the first torsion spring 16 via the first shaft 19, may be provided at any position of the first shaft 19. With this, a rotation speed of the first shaft 19 decreases, and as a result, a speed at which the first torsion spring 16 twists decreases, then the damping force is applied to the first torsion spring 16. This rotary damper mechanism is a well-known rotary damper mechanism using viscous resistance (viscous drag) of oil, and has a case, a rotor accommodated in the case together with oil, and a cap having a shaft portion through hole, which a shaft portion of the rotor penetrates, and covering the case. Here, to increase the rotation speed of the first shaft 19 (to turn it further), the oil may be throttled back, and to rotate the first shaft 19 in one rotation direction then rotate the first shaft 19 in the other rotation direction (to turn it back), the oil may be bypassed via a flow passage provided in the rotary damper mechanism.

Here, two-stage spring characteristics (double spring characteristics) using the first torsion spring 16 and the second torsion spring 17 will be described with reference to FIG. 6. First, a spring constant of the first torsion spring 16 is defined as “K1”, and a spring constant of the second torsion spring 17 is defined as “K2”. As shown in FIG. 6, when the operation angle is from 0 degrees to less than 60 degrees (in a small steering angle region), the urging force of only the first torsion spring 16 acts on the shaft 4. Therefore, an operation force applied to the shaft 4 increases linearly against a reaction force based on the spring constant K1 (an operation force gain K1). Then, when the operation angle reaches 60 degrees and the operation force reaches the predetermined load, approximately 0.17 Nm in the present embodiment, the urging force of the second torsion spring 17 also acts in addition to the urging force of first torsion spring 16. Therefore, a resultant spring constant (a combined spring constant) K obtained by regarding the first torsion spring 16 and the second torsion spring 17 as being connected in series can be obtained from an equation of “1/K=1/K1+1/K2”. As described above, since the spring constant of the first torsion spring 16 and the spring constant of the second torsion spring 17 in the present embodiment are the same, an equation of “1/K=2/K1” holds, and this equation gives “K=K1/2” when rearranged. Therefore, in the present embodiment, in a region where the operation angle is from 60 degrees to 180 degrees (in a large steering angle region), the operation force applied to the shaft 4 increases linearly against a reaction force based on the resultant spring constant K1/2 (an operation force gain K1/2). That is, as shown in FIG. 6, the operation force in the large steering angle region increases linearly at half an increase rate of the operation force in the small steering angle region. Therefore, in the large steering angle region, the dial 1 is operated with half the force in comparison with the operation force in the small steering angle region. Here, the present embodiment exemplifies a case where the spring constant of the first torsion spring 16 and the spring constant of the second torsion spring 17 are the same. However, different spring constants could be used according to desired reaction force characteristics.

The closing member 18 is formed into a disk shape with a metal material or a resin. An axial direction other end portion, on the other end portion 19b side, of the first housing 33 is fixed to one end portion 19a side of the closing member 18. At a center portion on a surface 18b, one end portion 19a side, of the closing member 18, a fourth bearing accommodating portion 40 recessed from the surface 18b to the other end portion 19b side is formed. The fourth bearing accommodating portion 40 accommodates the fourth ball bearing 26 rotatably supporting the step-reduced diameter portion 19j provided at the second small diameter portion 19f.

The present embodiment exemplifies a case where the first torsion spring 16 is attached to the large diameter portion 19e of the first shaft 19 via the first arc groove 23 and the second arc groove 24 of the first shaft 19 in the state in which no pre-load is applied to the spring. However, in consideration of the friction generated between the first shaft 19 and the seal member provided at the annular groove portion 34g, the first torsion spring 16 could be attached to the large diameter portion 19e of the first shaft 19 with a pre-load equivalent to torque caused by the friction being applied to the first torsion spring 16. When the friction (the feeling of viscosity) generated between the first shaft 19 and the seal member is given by the seal member, the first torsion spring 16 becomes difficult to return to the neutral position. Therefore, by applying the pre-load equivalent to torque caused by the friction, it is possible to prevent the first torsion spring 16 from becoming difficult to return to the neutral position. This improves the feel of operation (the steering feel) of the dial by the driver.

### Effects of First Embodiment

As described above, in the first embodiment, the first torsion spring 16 generates, regardless of the rotation direction of the first shaft 19, the urging force in the opposite direction to the rotation direction of the first shaft 19. That is, upon the right rotation of the first shaft 19, the first torsion spring 16 provides the urging force in the left rotation direction to the first shaft 19, whereas upon the left rotation of the first shaft 19, the first torsion spring 16 provides the urging force in the right rotation direction to the first shaft 19. More specifically, as compared with the related art technique in which springs as the dedicated urging members to provide the urging force (the reaction force) against each of the rotation directions of the shaft are provided, in the present embodiment, the shared first torsion spring 16 generating the urging force for both the rotation directions is provided. Therefore, since the number of the springs is reduced in comparison with the related art technique, it is possible to reduce the manufacturing costs of the steering operation input device.

Further, in the related art technique, the single spring is provided to apply the urging force for the right rotation of the shaft, and the other single spring is provided to apply the urging force for the left rotation of the shaft. As a consequence, there arises a problem that the urging force is different between upon the right rotation of the shaft and upon the left rotation of the shaft.

In contrast, in the present embodiment, since the shared first torsion spring 16 applies the urging force upon both the right rotation and the left rotation of the first shaft 19, the difference in the urging force between upon the right rotation and the left rotation can be eliminated.

Furthermore, in the related art technique, switching of the springs between upon the right rotation and the left rotation of the shaft is performed via the linear motion conversion device that converts the rotational force, which is input from the steering operation input member, into the linear motion.

However, in the present embodiment, since the shared first torsion spring 16 applies the urging force upon both the rotations of the first shaft 19, the present embodiment does not require the linear motion conversion device as in the related art technique. Therefore, as compared with the related art technique, it is possible to reduce the manufacturing costs and an assembly time of the steering operation input device by the amount of a linear motion conversion mechanism.

In addition, in the present embodiment, a configuration in which after the first torsion spring 16 applies the urging force to the first shaft 19, the second torsion spring 17 applies the urging force to the second shaft 20 may be used. In this case, even if the rotation of the first torsion spring 16 providing the urging force to the first shaft 19 stops, by the switching device, the urging force is provided to the shaft 4 only by the second torsion spring 17. Therefore, even in a case where the first torsion spring 16 fails, the urging force is provided to the shaft 4 by the second torsion spring 17, thereby continuing the operation of the steering operation input device.

Moreover, in the present embodiment, even after the urging force by the second torsion spring 17 is applied to the second shaft 20, the first torsion spring 16 continues applying the urging force to the first shaft 19. In this case, since a switching device having the above-mentioned configuration in which after the first torsion spring 16 provides the urging force to the first shaft 19, the second torsion spring 17 provides the urging force to the second shaft 20 is not necessary, it is possible to manufacture the steering operation input device more easily than the above-mentioned configuration.

Additionally, in the present embodiment, the steering operation input device has the position switching mechanism 39 that switches between the non-fixed position and the fixed position of the first bent portion 16e of the first spring end portion 16b or the second bent portion 16g of the second spring end portion 16c of the first torsion spring 16 upon the rotation of the first shaft 19. Therefore, only by switching the position of the first bent portion 16e or the second bent portion 16g according to the rotation of the first shaft 19, it is possible to easily provide the urging force in the opposite direction to the rotation of the first shaft 19, without moving a linear motion member over a relatively long distance by the linear motion conversion mechanism as in the related art technique. Further, in the related art technique, a load due to the springs and the linear motion conversion mechanism acts on the shaft. However, in the present embodiment, only a load from the first torsion spring 16 and the second torsion spring 17 acts on the first shaft 19 etc. Therefore, a load on the steering operation input device can be reduced.

Furthermore, in the related art technique, two coil springs are disposed along an axial direction of the shaft, then the linear motion conversion mechanism is provided. Also, in the related art technique, there is a need to design the steering operation input device with consideration given to stroke of each coil spring along the axial direction of the shaft. Consequently, the steering operation input device tends to increase in size.

However, in the present embodiment, the first torsion spring 16 and the second torsion spring 17 are used as the urging members. Since expansion, after being deformed, of each of the first torsion spring 16 and the second torsion spring 17 is relatively small and each spring generates the urging force only by being twisted in a circumferential direction of the spring, a size (a dimension), along the axial direction of the first shaft 19, of the steering operation input device can be shortened in comparison with the related art technique.

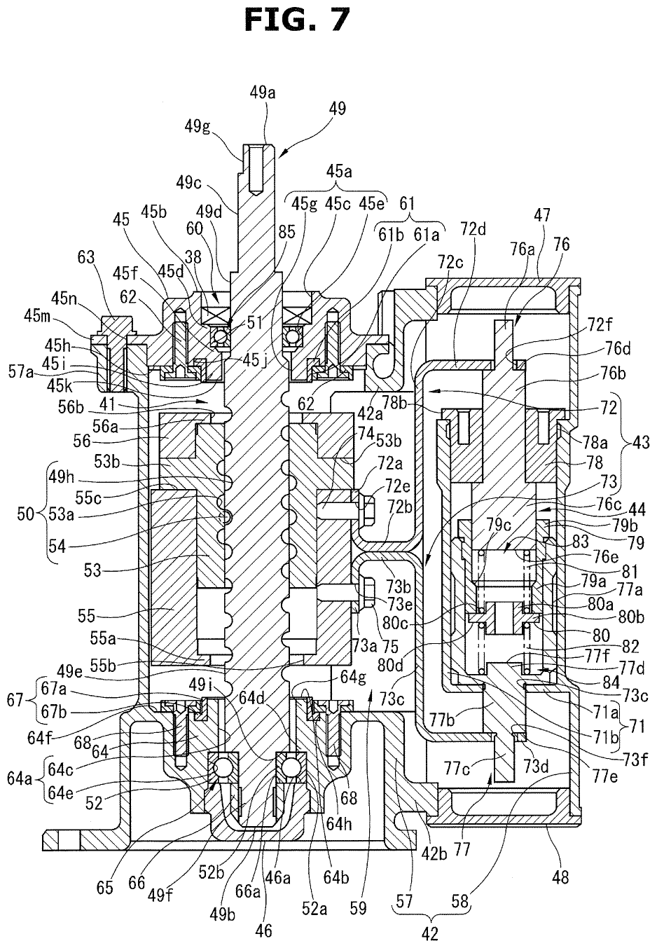

In order to shorten the axial dimension of the steering operation input device, as a configuration, it is conceivable that two coil springs are arranged in series, and the linear motion conversion mechanism is disposed at a radially outer side of these coil springs (see FIG. 7). However, since the present embodiment does not require the linear motion conversion mechanism, as compared with a steering operation input device according to a second embodiment described later, size reduction, along the radial direction of the first shaft 19, of the steering operation input device can be achieved.

In the present embodiment, the shaft 4 includes the first shaft 19 provided with the first torsion spring 16, and the second shaft 20 provided with the second torsion spring 17. Also, the coupling member 13 covering the first shaft 19 and the first torsion spring 16 is provided at an outer side in the radial direction of the first shaft 19. The coupling member 13 is connected to the first shaft 19 via the first torsion spring 16, and also connected to the second shaft 20. Then, the coupling member 13 rotates when the first torsion spring 16 reaches the predetermined load. By and according to this rotation of the coupling member 13, the second shaft 20 rotates, then the second torsion spring 17 provided at the second shaft 20 is twisted. Because of this, until the first torsion spring 16 reaches the predetermined load, the urging force based only on the first torsion spring 16 is generated. After the first torsion spring 16 reaches the predetermined load, the urging force based on the first torsion spring 16 and the second torsion spring 17 is generated. With this, as shown in FIG. 6, the operation force of the dial 1 changes in two stages across an operation angle of 60 degrees. That is, the operation force increases at a predetermined increase rate (gradient of increase) until the operation angle reaches 60 degrees, and after 60 degrees, the operation force increases at half the increase rate when the operation angle is less than 60 degrees. Therefore, in the large steering angle region where the operation angle is 60 degrees or greater, fatigue of the driver caused by steering can be reduced, and deterioration in controllability (drivability or handling comfort) of the vehicle can be suppressed.

Further, in the present embodiment, the predetermined load is a load generated by the pre-load having been set in (applied to) the second torsion spring 17. Therefore, by changing the pre-load, it is possible to adjust a point at which the operation force changes.

Furthermore, in the present embodiment, an outside diameter of the first shaft 19 is set to be smaller than an inside diameter of the first torsion spring 16 when the first torsion spring 16 generates the urging force and is deformed. Therefore, damage to the first torsion spring 16 and the first shaft 19 caused by the deformed first torsion spring 16 coming into contact with an outer peripheral surface of the first shaft 19 can be suppressed. Also, it is possible to prevent the rotation of the first shaft 19 from being stopped due to the deformed first torsion spring 16 coming into contact with the outer peripheral surface of the first shaft 19.

Moreover, in the present embodiment, the D-cut portion is formed on the outer peripheral surface of the small diameter tubular portion 13a of the coupling member 13, and the coupling member 13 is fixed to the first through hole 20a of the second shaft 20 via the D-cut portion. Therefore, when assembling the second shaft 20 to the coupling member 13, positioning of the second shaft 20, particularly third arc groove 27, can be readily done by the D-cut portion.

In addition, in the present embodiment, the coupling member 13 and the second shaft 20 may be fixed to each other via the spline portion. In this case, even when a rotation torque generated at the coupling member 13 is large, the coupling member 13 and the second shaft 20 can be fixed together firmly.

Additionally, in the present embodiment, the annular groove portion 34g of the second housing 34 is provided with the O-ring 38 as a seal member. The O-ring 38 seals the gap between the inner peripheral surface of the expansion portion 34c of the second housing 34 and the outer peripheral surface of the first small diameter portion 19c of the first shaft 19. Therefore, since the first shaft 19 rotates against a frictional force of the O-ring 38, the feeling of viscosity at the beginning of turning of the dial 1 is generated. Thus, the feel of operation (the steering feel) of the dial by the driver can be improved.

Also, in the present embodiment, the damper mechanism that applies a damping force to the first torsion spring 16 may be provided at any position of the first shaft 19. In this case, the urging force of the first torsion spring 16 is attenuated (damped), thereby reducing the operation force of the dial 1 by the driver, and reducing driver's fatigue.

### Second Embodiment

FIG. 7 is a longitudinal cross section of a steering operation input device according to a second embodiment. FIG. 7 shows the steering operation input device at a neutral position.

The steering operation input device of the second embodiment includes a rotation/linear motion conversion unit 41, a housing 42, a linkage unit 43, a reaction force generation unit 44, a first closing lid member 45, a second closing lid member 46, a third closing lid member 47, and a fourth closing lid member 48. In this steering operation input device, a rotational force input to a third shaft 49 described below is converted into linear motion by the rotation/linear motion conversion unit 41, and this linear motion is transmitted to the reaction force generation unit 44 via the linkage unit 43. The reaction force generation unit 44 transmits urging forces of after-described first coil spring 81 and second coil spring 82, which are urged in response to the transmitted linear motion, to the rotation/linear motion conversion unit 41 via the linkage unit 43.

The rotation/linear motion conversion unit 41 includes the third shaft 49, and a linear motion conversion mechanism 50 that is a ball screw mechanism provided at an outer peripheral portion of the third shaft 49.

The third shaft 49 includes a first small diameter cylindrical columnar portion 49c located on one end portion 49a side, a medium diameter cylindrical columnar portion 49d formed integrally with the first small diameter cylindrical columnar portion 49c and having a larger diameter than the first small diameter cylindrical columnar portion 49c, a large diameter cylindrical columnar portion 49e formed integrally with the medium diameter cylindrical columnar portion 49d and having a larger diameter than the medium diameter cylindrical columnar portion 49d, and a second small diameter cylindrical columnar portion 49f formed integrally with the large diameter cylindrical columnar portion 49e and having a smaller diameter than the large diameter cylindrical columnar portion 49e. A D-cut portion 49g for fixing to a dial (not shown) to which a steering operation is input is formed at the first small diameter cylindrical columnar portion 49c. A fifth ball bearing 51, which is a bearing for rotatably supporting the medium diameter cylindrical columnar portion 49d, and an O-ring 38 as a seal member, are provided at an outer peripheral portion of the medium diameter cylindrical columnar portion 49d. As in the first embodiment, the seal member is not limited to the O-ring 38. For instance, an oil seal or a dust seal could be provided. Further, the oil seal or the dust seal may be provided together with the O-ring 38. The linear motion conversion mechanism 50, which converts a rotational force input to the third shaft 49 from the dial (not shown) into linear motion along an axial direction of the third shaft 49, is provided at an outer peripheral portion of the large diameter cylindrical columnar portion 49e. The linear motion conversion mechanism 50 will be described in detail later. A sixth ball bearing 52, which is a bearing for rotatably supporting the second small diameter cylindrical columnar portion 49f, is provided at an outer peripheral portion of the second small diameter cylindrical columnar portion 49f.

The linear motion conversion mechanism 50 is configured by a shaft-side ball screw groove 49h which is a spiral groove formed on an outer peripheral surface of the large diameter cylindrical columnar portion 49e of the third shaft 49, a nut-side ball screw groove 53a which is a spiral groove formed on an inner peripheral surface of a nut 53 that is a linear motion member, a plurality of balls 54 disposed between the ball screw grooves 49h and 53a, a restriction member 55 which restricts rotation of the nut 53 in a rotation direction of the third shaft 49, and allows movement of the nut 53 along the axial direction of the third shaft 49, and a cap member 56 which holds the nut 53 against the restriction member 55. The balls 54 rotatably support the nut 53 relative to the large diameter cylindrical columnar portion 49e of the third shaft 49. The nut 53 has a ring-shaped annular protruding portion 53b protruding radially outward from an outer peripheral surface of the nut 53. The annular protruding portion 53b is provided at a position closer to an axial direction end portion, on one end portion 49a side, of the nut 53. The restriction member 55 is formed into a bottomed cylindrical tubular shape, and provided in a posture in which a bottom portion 55a is located on the other end portion 49b side. On the bottom portion 55a of the restriction member 55, a restriction member through hole 55b is formed so as to penetrate the bottom of the restriction member 55 along the axial direction of the third shaft 49. The large diameter cylindrical columnar portion 49e of the third shaft 49 is inserted into the restriction member through hole 55b. The restriction member 55 is fixed to the nut 53 with an axial direction end 55c, on one end portion 49a side, of the restriction member 55 abutting against a first abutment surface 53b, on the other end portion 49b side, of the annular protruding portion 53b of the nut 53. The restriction member 55 is configured so as to be able to move smoothly along the axial direction of the third shaft 49 by a guide rail (not shown) provided at a conversion unit-side housing portion 57 described later.

The cap member 56 is formed into a bottomed cylindrical tubular shape that is shorter than the restriction member 55, and provided in a posture in which a bottom portion 56a is located on one end portion 49a side. On the bottom portion 56a of the cap member 56, a cap member through hole 56b is formed so as to penetrate the bottom of the cap member 56 in the axial direction of the third shaft 49. The large diameter cylindrical columnar portion 49e of the third shaft 49 is inserted into the cap member through hole 56b. In addition, a female thread portion (not shown) is provided on an inner peripheral surface of the cap member 56. This female thread portion is fitted onto a male thread portion (not shown) provided on the outer peripheral surface of the nut 53, thereby pressing the annular protruding portion 53b of the nut 53 against the axial direction end 55c of the restriction member 55.

Here, instead of the above linear motion conversion mechanism 50 that is the ball screw mechanism, a linear motion conversion mechanism using thread engagement may be applied to the steering operation input device of the present embodiment. In this case, the linear motion conversion mechanism includes a spiral first uneven portion (a male thread portion) formed on an outer peripheral surface of the third shaft 49, a nut, as a movable member, having a spiral second uneven portion (a female thread portion) that is engaged with the first uneven portion, and being movable in the axial direction of the third shaft 49 according to a rotation operation of the dial (not shown), and a restriction member which restricts rotation of the nut in the rotation direction of the third shaft 49, and allows movement of the nut along the axial direction of the third shaft 49.

The housing 42 includes the substantially bottomed cylindrical tubular shaped conversion unit-side housing portion 57 accommodating therein a part of the third shaft 49 and the linear motion conversion mechanism 50, and a substantially cylindrical tubular shaped generation unit-side housing portion 58 located at a radially outer side of the conversion unit-side housing portion 57 and accommodating therein the reaction force generation unit 44. As illustrated in FIG. 7, the housing 42 is structured so that after a part of an outer peripheral portion of the conversion unit-side housing portion 57 and a part of an outer peripheral portion of the generation unit-side housing portion 58 are joined together, a communication portion 59, at which the inside of the conversion unit-side housing portion 57 and the inside of the generation unit-side housing portion 58 communicate with each other, is provided at this joined portion.

An opening, on one end portion 49a side, of the conversion unit-side housing portion 57 is closed by the first closing lid member 45. The first closing lid member 45 is formed into a cylindrical tubular shape having a lid member through hole 45a at a center portion thereof. The medium diameter cylindrical columnar portion 49d and the large diameter cylindrical columnar portion 49e of the third shaft 49 are inserted into the lid member through hole 45a. An inner peripheral surface of the lid member through hole 45a has a first inner peripheral surface portion 45c adjacent to a lid member end portion 45b, on one end portion 49a side, of the lid member through hole 45a, a second inner peripheral surface portion 45e connected to the first inner peripheral surface portion 45c via a first step portion 45d and having a smaller diameter than the first inner peripheral surface portion 45c, and a third inner peripheral surface portion 45g connected to the second inner peripheral surface portion 45e via a second step portion 45f and having a smaller diameter than the second inner peripheral surface portion 45e. A space inside the first inner peripheral surface portion 45c is an O-ring accommodating portion 60 that accommodates the O-ring 38. A space inside the second inner peripheral surface portion 45e is a fifth bearing accommodating portion 85 that accommodates the fifth ball bearing 51 which is the bearing for rotatably supporting the medium diameter cylindrical columnar portion 49d of the third shaft 49. On a surface 45h, on the other end portion 49b side, of the first closing lid member 45, at a position adjacent to the third inner peripheral surface portion 45g, a ring-shaped lid member-side annular protruding portion 45i that protrudes from the surface 45h to the other end portion 49b side is formed. Further, on the surface 45h of the first closing lid member 45, at a position adjacent to the lid member-side annular protruding portion 45i, a ring-shaped lid member-side annular recessed portion 45j that is recessed from the surface 45h to the other end portion 49b side is formed.

A first stopper rubber 61 made of rubber is provided at an outer peripheral portion of the lid member-side annular protruding portion 45i and the lid member-side annular recessed portion 45j. The first stopper rubber 61 mitigates a collision of the cap member 56 with the lid member-side annular protruding portion 45i and the resulting hitting noise (or striking sound) when the nut 53 of the linear motion conversion mechanism 50 moves to the one end portion 49a side along the axial direction of the third shaft 49. The first stopper rubber 61 has a first tubular body 61a having a tubular shape, and an annular first overhang portion 61b protruding from an outer peripheral edge portion, on one end portion 49a side, of the first tubular body 61a to the radially outer side of the third shaft 49. The first stopper rubber 61 is disposed at the outer peripheral portion of the lid member-side annular protruding portion 45i so that the first overhang portion 61b is located inside the lid member-side annular recessed portion 45j, and also a tip portion of the first tubular body 61a is positioned on the other end portion 49b side with respect to a first protrusion surface portion 45k, on the other end portion 49b side, of the lid member-side annular protruding portion 45i. Then, by pressing the first overhang portion 61b against a bottom surface of the lid member-side annular recessed portion 45j to the one end portion 49a side by head portions of a plurality of fixing members, e.g. bolts 62 (in the present embodiment, two bolts 62 are shown), the first stopper rubber 61 is attached to the first closing lid member 45. Further, the first closing lid member 45 has an annular closing member flange portion 45m that expands outward in the radial direction of the third shaft 49 from an outer peripheral portion of the first closing lid member 45. The closing member flange portion 45m is mounted and fixed to a housing flange portion 57a provided at the conversion unit-side housing portion 57 by screwing a fixing member, e.g. a bolt 63, into the flange portion 57a of the conversion unit-side housing portion 57 via a fixing member through hole 45n provided at the closing member flange portion 45m.

At a position facing the linear motion conversion mechanism 50 inside the conversion unit-side housing portion 57, a bottom wall portion 64 is provided integrally with an inner peripheral portion of the conversion unit-side housing portion 57. The bottom wall portion 64 is formed into a substantially cylindrical tubular shape having a bottom wall portion through hole 64a at a center portion thereof. The large diameter cylindrical columnar portion 49e and the second small diameter cylindrical columnar portion 49f of the third shaft 49 are inserted into the bottom wall portion through hole 64a. The bottom wall portion through hole 64a has a first inside surface portion 64c adjacent to a bottom wall portion end portion 64b located on one end portion 49a side, and a second inside surface portion 64e connected to the first inside surface portion 64c via a stepped intermediate portion 64d and having a larger diameter than the first inside surface portion 64c. A space inside a portion adjacent to the stepped intermediate portion 64d at the second inside surface portion 64e is a sixth bearing accommodating portion 65 that accommodates the sixth ball bearing 52 which is the bearing for rotatably supporting the second small diameter cylindrical columnar portion 49f of the third shaft 49.

In addition, a female thread portion is formed at a portion, on the other end portion 49b side, of the second inside surface portion 64e, and this female thread portion is screwed onto a male thread portion provided on an outer peripheral surface of the cup-shaped second closing lid member 46. This screw-fastening causes an axial end surface 46a provided at the second closing lid member 46 to press an outer race 52a of the sixth ball bearing 52 against the stepped intermediate portion 64d, thereby fixing the outer race 52a between the bottom wall portion 64 and the second closing lid member 46. Furthermore, on an outer peripheral surface of the second small diameter cylindrical columnar portion 49f, at a portion located on the other end portion 49b side with respect to the sixth ball bearing 52, a male thread portion is formed, and this male thread portion is screwed onto a female thread portion formed on an inner peripheral surface of a ring-shaped pressing member 66. This screw-fastening causes a pressing surface 66a provided at the pressing member 66 on one end portion 49a side to press an inner race 52b of the sixth ball bearing 52 against an abutment surface 49i of the large diameter cylindrical columnar portion 49e, thereby fixing the inner race 52b between the third shaft 49 and the pressing member 66. Moreover, on a surface 64f, on one end portion 49a side, of the bottom wall portion 64, at a position close to the first inside surface portion 64c, a ring-shaped bottom wall portion-side annular protruding portion 64g is formed so as to protrude from the surface 64f toward the one end portion 49a. Also, on the surface 64f of the bottom wall portion 64, at a position close to the bottom wall portion-side annular protruding portion 64g, a ring-shaped bottom wall portion-side annular recessed portion 64h recessed from the surface 64f to the other end portion 49b side is formed.

A second stopper rubber 67 made of rubber is provided at an outer peripheral portion of the bottom wall portion-side annular protruding portion 64g and the bottom wall portion-side annular recessed portion 64h. The second stopper rubber 67 mitigates a collision of the restriction member 55 with the bottom wall portion-side annular protruding portion 64g and the resulting hitting noise (or striking sound) when the nut 53 of the linear motion conversion mechanism 50 moves to the other end portion 49b side along the axial direction of the third shaft 49. The second stopper rubber 67 has a second tubular body 67a having a tubular shape, and an annular second overhang portion 67b protruding from an outer peripheral edge portion, on the other end portion 49b side, of the second tubular body 67a to the radially outer side of the third shaft 49. The second stopper rubber 67 is disposed at the outer peripheral portion of the bottom wall portion-side annular protruding portion 64g so that the second overhang portion 67b is located inside the bottom wall portion-side annular recessed portion 64h, and also a tip portion of the second tubular body 67a is positioned on one end portion 49a side with respect to the bottom wall portion end portion 64b, on one end portion 49a side, of the bottom wall portion-side annular protruding portion 64g. Then, by pressing the second overhang portion 67b against a bottom surface of the bottom wall portion-side annular recessed portion 64h to the other end portion 49b side by head portions of a plurality of fixing members, e.g. bolts 68 (in the present embodiment, two bolts 68 are shown), the second stopper rubber 67 is attached to the bottom wall portion 64.

The generation unit-side housing portion 58 is joined to the outer peripheral portion of the conversion unit-side housing portion 57 by a one end portion-side housing joining portion 42a located on one end portion 49a side and the other end portion-side housing joining portion 42b located on the other end portion 49b side. An opening provided at the generation unit-side housing portion 58 on one end portion 49a side is closed by the third closing lid member 47, whereas an opening provided at the generation unit-side housing portion 58 on the other end portion 49b side is closed by the fourth closing lid member 48.

A small tubular portion 71 shaped into a bottomed tubular shape having a smaller diameter than an outside diameter of the generation unit-side housing portion 58 is integrally formed at an inner peripheral portion of the generation unit-side housing portion 58. The small tubular portion 71 has a bottom portion 71a formed at a position closer to the fourth closing lid member 48, and a peripheral wall portion 71b standing from an outer edge portion of the bottom portion 71a toward the third closing lid member 47. The bottom portion 71a is arranged inside the generation unit-side housing portion 58 so as to be positioned on one end portion 49a side with respect to a position of the surface 64f of the bottom wall portion 64 of the conversion unit-side housing portion 57 in the axial direction of the third shaft 49. An insertion hole 73c, into which a large shaft portion 77b of a second shaft portion 77 both described later is inserted, is formed at a center portion of the bottom portion 71a so as to penetrate the bottom portion 71a along the axial direction of the third shaft 49. The peripheral wall portion 71b extends, inside the generation unit-side housing portion 58, from the outer edge portion of the bottom portion 71a to a position close to the one end portion-side housing joining portion 42a in the axial direction of the third shaft 49.

Most of the linkage unit 43 is arranged inside the generation unit-side housing portion 58 and the communication portion 59. The linkage unit 43 links the restriction member 55 of the linear motion conversion mechanism 50 and the reaction force generation unit 44. As illustrated in FIG. 7, the linkage unit 43 includes a first linkage half portion 72, and a second linkage half portion 73, which are provided symmetrically in the axial direction of the third shaft 49. The first linkage half portion 72 and the second linkage half portion 73 are each formed by bending a thin plate-shaped member made of a metal material three times.

The first linkage half portion 72 has a first fixing portion 72a fixed to the restriction member 55, a first bent piece portion 72b bent at a right angle from the first fixing portion 72a toward the reaction force generation unit 44, a second bent piece portion 72c bent at a right angle from one end of the first bent piece portion 72b toward the third closing lid member 47, and a third bent piece portion 72d bent at a right angle from one end of the second bent piece portion 72c to an opposite side to the first bent piece portion 72b. A first fixing hole 72e is formed at the first fixing portion 72a so as to penetrate the first fixing portion 72a. By screwing a fixing member, e.g. a bolt 74, into an outer peripheral portion of the restriction member 55 through this first fixing hole 72e, the first fixing portion 72a is attached and fixed to the restriction member 55. At a position close to a free end of the third bent piece portion 72d, a first insertion hole 72f, into which a small shaft portion 76a of a first shaft portion 76 both described later is inserted, is formed so as to penetrate the third bent piece portion 72d along the axial direction of the third shaft 49.

The second linkage half portion 73 has the same shape as that of the first linkage half portion 72. The second linkage half portion 73 has a second fixing portion 73a fixed to the restriction member 55, a fourth bent piece portion 73b bent at a right angle from the second fixing portion 73a toward the reaction force generation unit 44, a fifth bent piece portion 73c bent at a right angle from one end of the fourth bent piece portion 73b toward the fourth closing lid member 48, and a sixth bent piece portion 73d bent at a right angle from one end of the fifth bent piece portion 73c to an opposite side to the fourth bent piece portion 73b. A second fixing hole 73e is formed at the second fixing portion 73a so as to penetrate the second fixing portion 73a. By screwing a fixing member, e.g. a bolt 75, into the outer peripheral portion of the restriction member 55 through this second fixing hole 73e, the second fixing portion 73a is attached and fixed to the restriction member 55. As shown in FIG. 7, a surface, located on one end portion 49a side, of the fourth bent piece portion 73b is butted against a surface, located on the other end portion 49b side, of the first bent piece portion 72b of the first linkage half portion 72. At a position close to a free end of the sixth bent piece portion 73d, a second insertion hole 73f, into which a small shaft portion 77c of the second shaft portion 77 both described later is inserted, is formed so as to penetrate the sixth bent piece portion 73d along the axial direction of the third shaft 49.

The reaction force generation unit 44 includes the first shaft portion 76, the second shaft portion 77, a first guide cylindrical tubular member 78, a second guide cylindrical tubular member 79, a spring connecting member 80, the first coil spring 81, and the second coil spring 82.

The first shaft portion 76 has the small shaft portion 76a located on the third closing lid member 47 side and having a small diameter, a medium shaft portion 76b formed integrally with the small shaft portion 76a and having a larger diameter than the small shaft portion 76a, and a large shaft portion 76c formed integrally with the medium shaft portion 76b and having a larger diameter than the medium shaft portion 76b. The first shaft portion 76 is provided at an outer side in the radial direction of the third shaft 49, and arranged parallel to the third shaft 49. Therefore, an axial direction of the first shaft portion 76 is parallel to the axial direction of the third shaft 49. Upon a left rotation of the third shaft 49, the nut 53 moves to the other end portion 49b side, and by and according to this movement, the first linkage half portion 72 moves to the fourth closing lid member 48 side. Then, when the first linkage half portion 72 moves to the fourth closing lid member 48 side, the third bent piece portion 72d of the first linkage half portion 72 presses a first pressing surface 76d, located on the third closing lid member 47 side, of the medium shaft portion 76b of the first shaft portion 76, and thus the first shaft portion 76 moves toward the fourth closing lid member 48.

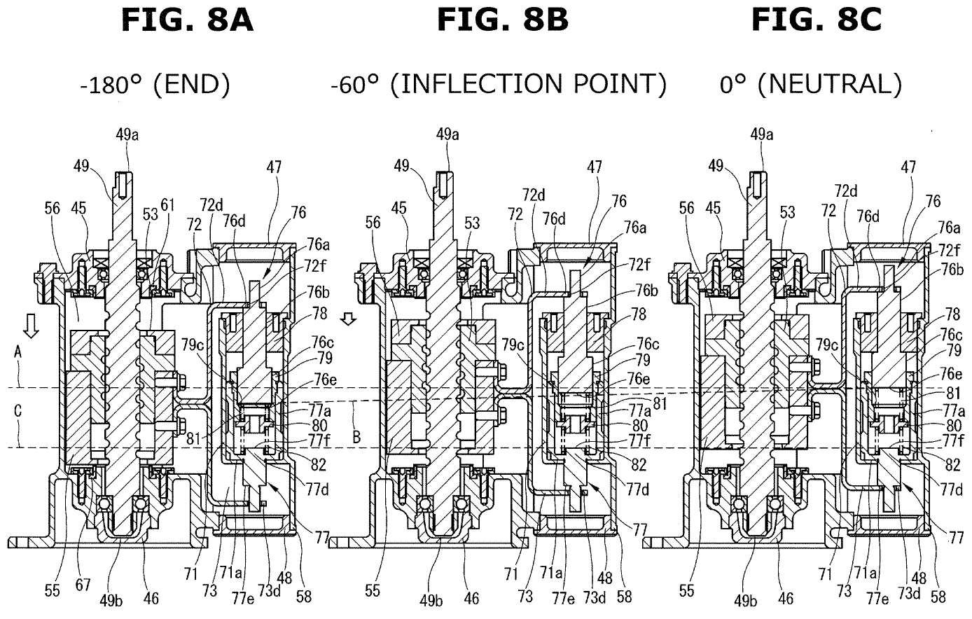

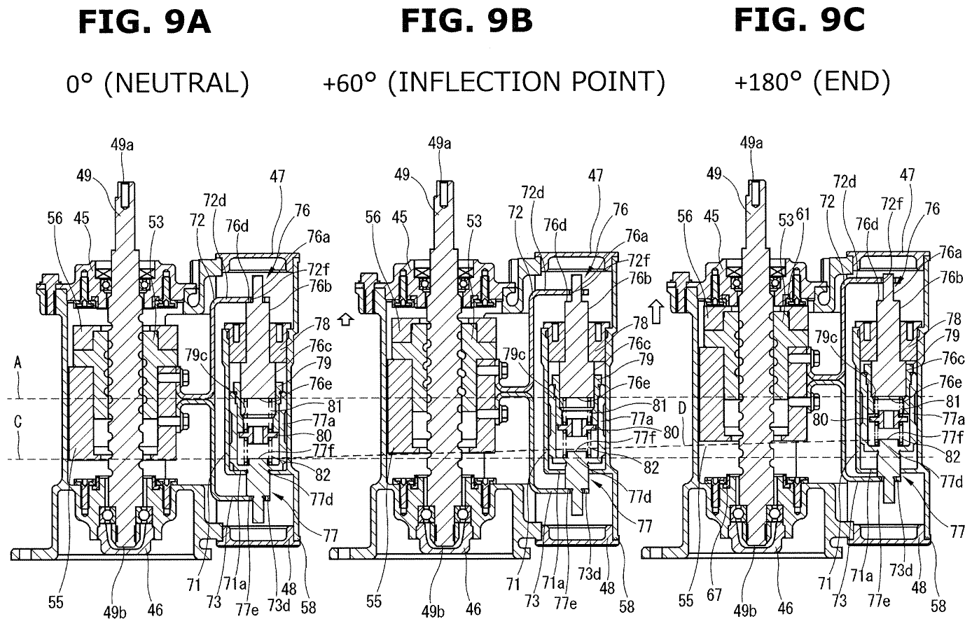

The second shaft portion 77 has a spring accommodation tubular portion 77a having a bottomed cylindrical tubular shape, the large shaft portion 77b protruding from a bottom of the spring accommodation tubular portion 77a toward the fourth closing lid member 48, the small shaft portion 77c formed integrally with the large shaft portion 77b and having a smaller diameter than the large shaft portion 77b, and a protruding portion 77d protruding from the bottom of the spring accommodation tubular portion 77a toward the third closing lid member 47. The second shaft portion 77 is arranged parallel to the third shaft 49. Therefore, an axial direction of the second shaft portion 77 is parallel to the axial direction of the third shaft 49. Upon a right rotation of the third shaft 49, the nut 53 moves to the one end portion 49a side, and by and according to this movement, the second linkage half portion 73 moves to the third closing lid member 47 side. Then, when the second linkage half portion 73 moves to the third closing lid member 47 side, the sixth bent piece portion 73d of the second linkage half portion 73 presses a second pressing surface 77e, located on the fourth closing lid member 48 side, of the large shaft portion 77b of the second shaft portion 77, and thus the second shaft portion 77 moves toward the third closing lid member 47. In the steering operation input device at the neutral position, a tip surface 77f of the protruding portion 77d is flush with an axial direction end surface, on the other end portion 49b side, of the restriction member 55 (see FIG. 8C and FIG. 9A).

The first guide cylindrical tubular member 78 slidably guides the medium shaft portion 76b of the first shaft portion 76 along the axial direction of the first shaft portion 76. The first guide cylindrical tubular member 78 has a first guide tubular portion 78a having a cylindrical tubular shape, and a ring-shaped first annular expansion portion 78b protruding radially outward from an outer periphery of an axial direction end portion, on the third closing lid member 47 side, of the first guide tubular portion 78a. The first guide tubular portion 78a is fixed to the peripheral wall portion 71b by, for instance, press-fitting.

The second guide cylindrical tubular member 79 slidably guides the large shaft portion 76c of the first shaft portion 76 along the axial direction of the first shaft portion 76. The second guide cylindrical tubular member 79 has a second guide tubular portion 79a having a cylindrical tubular shape, and a ring-shaped second annular expansion portion 79b protruding radially outward from an outer periphery of an axial direction end portion, on the third closing lid member 47 side, of the second guide tubular portion 79a. An inner peripheral surface of the second guide tubular portion 79a has an inclined portion 79c that is inclined so that an inside diameter of the second guide tubular portion 79a decreases from the third closing lid member 47 side toward the fourth closing lid member 48. As illustrated in FIG. 7, in the steering operation input device at the neutral position, an axial portion end surface 76e, on the fourth closing lid member 48 side, of the large shaft portion 76c of the first shaft portion 76 is positioned at a position, closer to the second annular expansion portion 79b, of the second guide tubular portion 79a. A space, located on the fourth closing lid member 48 side with respect to the large shaft portion 76c of the first shaft portion 76, inside the second guide cylindrical tubular member 79 is a first spring accommodating portion 83 accommodating the first coil spring 81 that is an urging member.

The spring connecting member 80 connecting the first coil spring 81 and the second coil spring 82 is provided at an axial direction end portion, on the fourth closing lid member 48 side, of the second guide cylindrical tubular member 79. The spring connecting member 80 has a connecting cylindrical tubular portion 80a having a cylindrical tubular shape, and a ring-shaped abutment expansion portion 80b protruding radially outward from an outer peripheral portion of an axial direction center of the connecting cylindrical tubular portion 80a. An outside diameter of the abutment expansion portion 80b is smaller than an inside diameter of the spring accommodation tubular portion 77a of the second shaft portion 77.

The first coil spring 81 is a linear coil spring provided in a state in which no pre-load is applied to the spring, i.e. in a state of free length. The first coil spring 81 is arranged at an outer side in the radial direction of the third shaft 49. That is, the first coil spring 81 extends parallel to the third shaft 49 inside the first spring accommodating portion 83 of the second guide cylindrical tubular member 79. Inside the first spring accommodating portion 83, one end of the first coil spring 81 abuts against the axial portion end surface 76e of the large shaft portion 76c of the first shaft portion 76, and the other end of the first coil spring 81 abuts against a first abutment surface 80c, on the third closing lid member 47 side, of the spring connecting member 80. Here, the inclined portion 79c also serves as a guide that, in a situation in which the first coil spring 81 may be displaced (may deviate) radially outward from an axis of the first shaft portion 76 due to external vibration, impact, etc., restricts the radially outward displacement (the radially outward deviation) of the first coil spring 81. In addition, the inclined portion 79c can serve as a stopper against which the axial portion end surface 76e of the large shaft portion 76c abuts when the first shaft portion 76 moves to the fourth closing lid member 48 side to its maximum extent.

A space, located on the fourth closing lid member 48 side with respect to the spring connecting member 80, inside the spring accommodation tubular portion 77a of the second shaft portion 77 is a second spring accommodating portion 84 accommodating the second coil spring 82.

The second coil spring 82 is a linear coil spring provided in a state in which a pre-load is applied to the spring. The second coil spring 82 is arranged at an outer side in the radial direction of the third shaft 49. That is, the second coil spring 82 extends parallel to the third shaft 49 inside the second spring accommodating portion 84 of the spring accommodation tubular portion 77a. Inside this second spring accommodating portion 84, one end of the second coil spring 82 abuts against a second abutment surface 80d, on the fourth closing lid member 48 side, of the spring connecting member 80, and the other end of the second coil spring 82 abuts against the bottom of the spring accommodation tubular portion 77a of the second shaft portion 77, around the protruding portion 77d.

Here, a damper mechanism for damping the urging force of the first coil spring 81, for instance, an axle-suspended damper mechanism similar to a suspension provided on the vehicle, may be provided between the one end of the first coil spring 81 and the axial portion end surface 76e of the large shaft portion 76c of the first shaft portion 76. Likewise, a damper mechanism for damping the urging force of the second coil spring 82, for instance, an axle-suspended damper mechanism similar to a suspension provided on the vehicle, may be provided between the other end of the second coil spring 82 and the bottom of the spring accommodation tubular portion 77a of the second shaft portion 77. In addition, this damper mechanism may be built into the large shaft portion 76c of the first shaft portion 76, the large shaft portion 77b or the protruding portion 77d of the second shaft portion 77.

FIGS. 8A to 8C are explanatory diagrams showing the operation or workings of the steering operation input device upon a left rotation of the third shaft 49. FIG. 8A is an explanatory diagram showing the steering operation input device when rotating the third shaft 49 leftward by 180 degrees from a neutral position. FIG. 8B is an explanatory diagram showing the steering operation input device when rotating the third shaft 49 leftward by 60 degrees from the neutral position. FIG. 8C is an explanatory diagram showing the steering operation input device at the neutral position. In FIGS. 8A to 8C, a position of the axial portion end surface 76e of the large shaft portion 76c of the first shaft portion 76 at the neutral position is indicated by a broken line A, and trajectory (locus) of the position of the axial portion end surface 76e of the large shaft portion 76c when rotating the third shaft 49 leftward from the neutral position to 180 degrees is indicated by a broken line B. Also, in 8A to 8C, a position of the tip surface 77f of the protruding portion 77d of the second shaft portion 77 is indicated by a broken line C. It is noted that in 8A to 8C, the position of the tip surface 77f is constant, that is, it is a position of the tip surface 77f at the neutral position.

First, when rotating the third shaft 49 leftward by 60 degrees (shown as “−60°” in FIG. 8B) from the neutral position shown in FIG. 8C, as illustrated in FIG. 8B, the nut 53 moves to the other end portion 49b side, and by and according to this movement, the first linkage half portion 72 moves to the fourth closing lid member 48 side together with the second linkage half portion 73. Then, the third bent piece portion 72d of the first linkage half portion 72 presses the first pressing surface 76d of the medium shaft portion 76b of the first shaft portion 76 toward the fourth closing lid member 48, and thus the first shaft portion 76 moves toward the fourth closing lid member 48, and compresses the first coil spring 81 against the spring connecting member 80. At this time, the sixth bent piece portion 73d of the second linkage half portion 73 is separated from the second pressing surface 77e of the large shaft portion 77b of the second shaft portion 77. The urging force of the first coil spring 81 generated due to the compression then acts on the nut 53 via the first shaft portion 76, the first linkage half portion 72 and the restriction member 55. With this, a reaction force corresponding to the urging force of the first coil spring 81 acts in a direction to rotate the third shaft 49 rightward.

Further, when rotating the third shaft 49 leftward from the position shown in FIG. 8B to a position of 180 degrees (shown as “−180°” in FIG. 8A), the nut 53 further moves to the other end portion 49b side, and by and according to this movement, the first linkage half portion 72 further moves to the fourth closing lid member 48 side together with the second linkage half portion 73. Here, the nut 53 moves until an axial direction end, on the other end portion 49b side, of the restriction member 55 abuts against the second stopper rubber 67. Then, the third bent piece portion 72d of the first linkage half portion 72 further presses the first pressing surface 76d of the medium shaft portion 76b of the first shaft portion 76 toward the fourth closing lid member 48, and thus the first shaft portion 76 further moves toward the fourth closing lid member 48. With this movement, the first shaft portion 76 further compresses the first coil spring 81 against the spring connecting member 80, and in addition, compresses the second coil spring 82 through the first coil spring 81 and the spring connecting member 80. At this time, the sixth bent piece portion 73d of the second linkage half portion 73 is further separated from the second pressing surface 77e of the large shaft portion 77b of the second shaft portion 77. Here, since the axial portion end surface 76e of the first shaft portion 76 abuts against the inclined portion 79c of the second guide cylindrical tubular member 79, movement of the first shaft portion 76 toward the fourth closing lid member 48 is restricted. The urging force of the first coil spring 81 and the second coil spring 82 generated due to each compression then further acts on the nut 53 via the first shaft portion 76, the first linkage half portion 72 and the restriction member 55. With this, a reaction force corresponding to the urging force of the first coil spring 81 and the second coil spring 82 further acts in a direction to rotate the third shaft 49 rightward.

FIGS. 9A to 9C are explanatory diagrams showing the operation or workings of the steering operation input device upon a right rotation of the third shaft 49. FIG. 9A is an explanatory diagram showing the steering operation input device at a neutral position. FIG. 9B is an explanatory diagram showing the steering operation input device when rotating the third shaft 49 rightward by 60 degrees from the neutral position. FIG. 9C is an explanatory diagram showing the steering operation input device when rotating the third shaft 49 rightward by 180 degrees from the neutral position. In 9A to 9C, a position of the axial portion end surface 76e of the large shaft portion 76c of the first shaft portion 76 is indicated by a broken line A. In 9A to 9C, the position of the axial portion end surface 76e is constant, that is, it is a position of the axial portion end surface 76e at the neutral position. Also, in 9A to 9C, a position of the tip surface 77f of the protruding portion 77d at the neutral position is indicated by a broken line C, and trajectory (locus) of the position of the tip surface 77f of the protruding portion 77d when rotating the third shaft 49 rightward from the neutral position to 180 degrees is indicated by a broken line D.

First, when rotating the third shaft 49 rightward by 60 degrees (shown as “+60°” in FIG. 9B) from the neutral position shown in FIG. 9A, as illustrated in FIG. 9B, the nut 53 moves to the one end portion 49a side, and by and according to this movement, the second linkage half portion 73 moves to the third closing lid member 47 side together with the first linkage half portion 72. Then, the sixth bent piece portion 73d of the second linkage half portion 73 presses the second pressing surface 77e of the large shaft portion 77b of the second shaft portion 77 toward the third closing lid member 47, and thus the second shaft portion 77 moves toward the third closing lid member 47, and compresses the first coil spring 81 via the second coil spring 82 and the spring connecting member 80. At this time, the third bent piece portion 72d of the first linkage half portion 72 is separated from the first pressing surface 76d of the medium shaft portion 76b of the first shaft portion 76. Also, the bottom of the spring accommodation tubular portion 77a of the second shaft portion 77 is separated from the bottom portion 71a of the small tubular portion 71 of the generation unit-side housing portion 58. The urging force of the first coil spring 81 generated due to the compression then acts on the nut 53 via the second shaft portion 77, the second linkage half portion 73 and the restriction member 55. With this, a reaction force corresponding to the urging force of the first coil spring 81 acts in a direction to rotate the third shaft 49 leftward.

Further, when rotating the third shaft 49 rightward from the position shown in FIG. 9B to a position of 180 degrees (shown as “+180°” in FIG. 9C), the nut 53 further moves to the one end portion 49a side, and by and according to this movement, the second linkage half portion 73 further moves to the third closing lid member 47 side together with the first linkage half portion 72. Here, the nut 53 moves until an axial direction end, on one end portion 49a side, of the cap member 56 abuts against the first stopper rubber 61. Then, the sixth bent piece portion 73d of the second linkage half portion 73 further presses the second pressing surface 77e of the large shaft portion 77b of the second shaft portion 77 toward the third closing lid member 47, and thus the second shaft portion 77 further moves toward the third closing lid member 47. With this movement, the second shaft portion 77 further compresses the first coil spring 81 between the large shaft portion 76c of the first shaft portion 76 and the spring connecting member 80, and in addition, compresses the second coil spring 82 against the spring connecting member 80. At this time, the axial portion end surface 76e of the first shaft portion 76 has abutted against the inclined portion 79c of the second guide cylindrical tubular member 79. The urging force of the first coil spring 81 and the second coil spring 82 generated due to each compression then further acts on the nut 53 via the second shaft portion 77, the second linkage half portion 73 and the restriction member 55. With this, a reaction force corresponding to the urging force of the first coil spring 81 and the second coil spring 82 further acts in a direction to rotate the third shaft 49 leftward.

### Effects of Second Embodiment

As described above, in the second embodiment, the steering operation input device includes the linear motion conversion mechanism 50 which converts the rotation of the third shaft 49 into the axial motion of the third shaft 49. The linear motion conversion mechanism 50 includes the nut 53 which moves in the axial direction of the third shaft 49. Further, the first coil spring 81 and the second coil spring 82 apply the urging force to the nut 53 via the linkage unit 43 and the restriction member 55. Therefore, since the urging force is applied to the movement of the nut 53 along the axial direction of the third shaft 49, the range of choices of the type of the urging member can be extended.

Furthermore, in the present embodiment, the linear motion conversion mechanism 50 includes the shaft-side ball screw groove 49h which is the spiral groove formed on the outer peripheral surface of the large diameter cylindrical columnar portion 49e of the third shaft 49, the nut-side ball screw groove 53a which is the spiral groove formed on an inner peripheral surface of the nut 53 that is the linear motion member, the plurality of balls 54 disposed between the ball screw grooves 49h and 53a, the restriction member 55 which restricts rotation of the nut 53 in the rotation direction of the third shaft 49, and allows movement of the nut 53 along the axial direction of the third shaft 49, and the cap member 56 which holds the nut 53 against the restriction member 55. That is, the linear motion conversion mechanism 50 is the ball screw mechanism. Therefore, since the nut 53 moves smoothly on the third shaft 49 by sliding via the plurality of balls 54 disposed between the ball screw grooves 49h and 53a, the rotation of the third shaft 49 can be quickly and efficiently converted into the linear motion.

In addition, in the present embodiment, the linear motion conversion mechanism is not the ball screw mechanism, but may be a linear motion conversion mechanism using thread engagement. In this case, the linear motion conversion mechanism can be manufactured using fewer parts than the ball screw mechanism, thereby reducing the manufacturing costs.

Moreover, in the present embodiment, the first coil spring 81 and the second coil spring 82 are arranged at the outer side in the radial direction of the third shaft 49, and extend parallel to the third shaft 49. That is, the first coil spring 81 and the second coil spring 82 are not provided on the third shaft 49 which is provided with the linear motion conversion mechanism 50. Therefore, only by replacing the first coil spring 81 and the second coil spring 82 at a position away from the linear motion conversion mechanism 50, it is possible to easily change the urging force applied to the steering operation input device.

In the present embodiment, as in the first embodiment, in consideration of friction generated, by a seal member, between the third shaft 49 and the seal member, the first coil spring 81 could be attached with a pre-load equivalent to torque caused by the friction being applied to the first coil spring 81. Further, a spring constant of the first coil spring 81 and a spring constant of the second coil spring 82 could be the same, or may be different.

### Third Embodiment

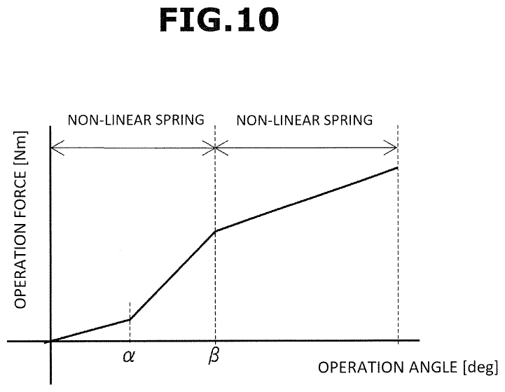

FIG. 10 is a graph showing an operation force with respect to an operation angle according to a third embodiment.

In the third embodiment, as the urging member, instead of the first coil spring 81 and the second coil spring 82 that are the linear springs of the second embodiment, two non-linear springs are used. The non-linear spring is, for instance, a barrel-shaped coil spring, a drum-shaped coil spring, or the like. In the third embodiment, the operation force changes in three stages with respect to the operation angle. More specifically, as shown in FIG. 10, by one non-linear spring, the operation force increases at a first increase rate until a first operation angle α, and increases at a second increase rate, which is greater than the first increase rate, from the first operation angle α to a second operation angle β, which is greater than the first operation angle α. Further, by the other non-linear spring, the operation force increases at a third increase rate, which is smaller than the second increase rate, after the second operation angle β.

### Effects of Third Embodiment

As described above, in the third embodiment, the two non-linear springs are used as the urging members. Therefore, in the third embodiment as well, the operation force decreases after the second operation angle β, thereby reducing driver's fatigue. In addition, when operating the dial so as to straddle the second operation angle β, for instance, when rotating the third shaft 49 from a right rotation to a left rotation and further adding the left rotation, the driver is less likely to feel a sense of wall.

1.-17. (canceled)

18. A steering operation input device into which driver's steering operation is input via a steering operation input member mounted on a vehicle, the steering operation input device comprising:
a shaft to which a steering force from the steering operation input member is transmitted, and which rotates on a rotation axis; and
an urging member which provides an urging force against rotation of the shaft,
wherein the urging member includes:
a first urging member which provides an urging force to the shaft regardless of a rotation direction of the shaft; and
a second urging member which is attached with a pre-load being applied to the second urging member, and which provides, after the first urging member provides the urging force, an urging force to the shaft regardless of the rotation direction of the shaft.

19. The steering operation input device as claimed in claim 18, wherein
even after the urging force by the second urging member is provided to the shaft, the first urging member continues providing the urging force to the shaft.

20. The steering operation input device as claimed in claim 19, further comprising
a position switching mechanism configured to switch between a non-fixed position and a fixed position of end portions of the first urging member and the second urging member when the shaft is rotated.

21. The steering operation input device as claimed in claim 20, wherein
the first urging member and the second urging member are each a torsion spring.

22. The steering operation input device as claimed in claim 21, wherein
the shaft includes a first shaft provided with the first urging member, and a second shaft provided with the second urging member,
a coupling member covering the first shaft and the first urging member is provided at an outer side in a radial direction of the first shaft,
the coupling member is connected to the first shaft via the first urging member, and also connected to the second shaft, and
the second shaft rotates together with the coupling member when the first urging member reaches a predetermined load.

23. The steering operation input device as claimed in claim 22, wherein
the predetermined load is a load generated by the pre-load having been applied to the second urging member.

24. The steering operation input device as claimed in claim 22, wherein
an outside diameter of the first shaft is smaller than an inside diameter of the first urging member when the first urging member generates the urging force and is deformed.

25. The steering operation input device as claimed in claim 22, wherein
the coupling member and the second shaft are fixed to each other via a D-cut portion.

26. The steering operation input device as claimed in claim 22, wherein
the coupling member and the second shaft are fixed to each other via a spline portion.

27. The steering operation input device as claimed in claim 18, wherein
the first urging member and the second urging member are each a non-linear spring.

28. The steering operation input device as claimed in claim 18, further comprising
a housing accommodating therein a part of the shaft, and the urging member,
wherein the housing is provided with a seal member that seals a gap between the housing and an outer peripheral surface of the shaft.

29. The steering operation input device as claimed in claim 18, further comprising
a damper mechanism configured to apply a damping force to the urging member.

30. The steering operation input device as claimed in claim 19, further comprising
a linear motion conversion mechanism configured to convert rotation of the shaft into axial motion of the shaft,
the linear motion conversion mechanism includes a linear motion member, and
the first urging member and the second urging member provide the urging force to the linear motion member.

31. The steering operation input device as claimed in claim 30, wherein
the first urging member and the second urging member are arranged at an outer side in a radial direction of the shaft, and extend parallel to the shaft.

32. The steering operation input device as claimed in claim 30, wherein
the linear motion conversion mechanism includes:
a spiral first uneven portion formed on an outer peripheral surface of the shaft;
a movable member having a spiral second uneven portion that is engaged with the first uneven portion, the movable member being movable in the axial direction of the shaft according to a rotation operation of the steering operation input member; and
a restriction member which restricts rotation of the movable member in the rotation direction of the shaft, and which allows movement of the movable member along an axial direction of the shaft.

33. The steering operation input device as claimed in claim 30, wherein
the linear motion conversion mechanism is a ball screw mechanism.

34. A steer-by-wire type steering device provided with the steering operation input device as claimed in claim 18.
